(19) United States
(12) Patent Application Publication
(10) Pub. No.: US 2002/0069677 A1
(43) Pub. Date: Jun. 13, 2002

(54) Optical fiber and method of making optical fiber

(76) Inventor: George E. Berkey, Pine City, NY (US)

Correspondence Address: CORNING INCORPORATED, SP-TI-3-1, CORNING, NY, 14831

(21) Appl. No.: 09/919,140

(22) Filed: Jul. 31, 2001

Related U.S. Application Data
(63) Continuation-in-part of application No. 08/844,997, filed on Apr. 23, 1997.
(60) Provisional application No. 60/016,435, filed on Apr. 29, 1996.

(51) Int. Cl. C03B 37/075

(52) U.S. Cl. 65/403

(57) ABSTRACT

An optical waveguide fiber suitable for making a spliced connection between two dissimilar optical waveguide fibers, the method of making the fiber, and the method of splicing dissimilar fibers to lower splice losses.

### RELATED APPLICATION

This application is a continuation-in-part of commonly assigned U.S. patent application Ser. No. 08/844,997 filed on Apr. 23, 1997, the contents of which are relied upon and incorporated herein by reference in its entirety.

### BACKGROUND OF THE INVENTION

1. Field of the Invention

The invention is directed to a optical waveguide fiber for use in telecommunication systems and more particularly, an optical fiber used to connect or bridge other optical fibers.

2. Technical Background

Dispersion compensating (DC) modules have been inserted along system optical fiber lengths where needed to compensate for accumulated dispersion. Such modules typically consist of between 4 km to 16 km of highly negative dispersion fiber. Some advanced modules have DC fiber that has a dispersion slope such that the dispersion is compensated perfectly across the 1530 to 1620 nm region. One main drawback with this compensation scheme is a considerable consumption of optical power by the DC modules. This lost power is of considerable importance, particularly in undersea systems. The following generation of undersea system will have dispersion compensating fiber cabled directly into the system rather than being provided as a module. One difficulty encountered with such a system is the joinder between the positive dispersion fiber and the negative dispersion (compensative) fiber. Splice losses or joining losses are typically high due to a large fiber modefield mismatch of the two fiber designs. For example, positive dispersion fiber has been designed to have a relatively large modefield, such as about 11-12 micron, in order to minimize non-linearities delivered by the high optical power launched into these fibers, and matching negative dispersion fibers may have modefields around 5-6 microns. Modefield fusion typically produces splicing losses around 0.7 dB/km.

In the past, bridge fibers or transition fibers or jumper fibers have been utilized in an attempt to lower splice losses. These relatively short length fibers were inserted between two other fibers wherein the bridge fiber had a modefield somewhere between the two system fibers. However, although the splice loss was lowered, the splice losses associated with known fibers are still relatively high.

### SUMMARY OF THE INVENTION

In one aspect, the present invention relates to a method of forming an optical waveguide fiber, the method comprising providing a preform comprising a fused silica tube, a first pellet disposed in the tube, and a second pellet disposed in the tube adjacent the first pellet, wherein the first and second pellets are of disparate types, and wherein adjacent surfaces of the first and second pellets form an interface; heating the preform; pulling on at least one end of the preform to draw an optical fiber therefrom, thereby stretching the interface into a transition region which contains at least a portion of both the first and second pellets; and severing a selected portion of the optical fiber, the selected portion containing at least part of the transition region, wherein the at least part of the transition region forms the majority of the length of the selected portion.

Preferably, the method further comprises applying a layer of silica soot to the exterior surface of the preform, and preferably then consolidating the layer of silica soot.

In a preferred embodiment, the selected portion has a length of less than about 10 m. In another preferred embodiment, the selected portion has a length of less than about 5 m. In yet another preferred embodiment, the selected portion has a length of less than about 3 m.

Preferably, the preform is fabricated by providing a fused silica tube, placing a first pellet into the tube, and placing a second pellet into the tube adjacent the first pellet.

The method further preferably comprises exposing the preform to a cleaning gas, even more preferably exposing the preform to a cleaning gas while being heated.

In a preferred embodiment, the selected portion contains essentially all of the transition region, wherein the transition region forms the majority of the length of the selected portion.

The heating step preferably comprises heating at least a portion of the preform to a temperature above about 1000° C. and less than the consolidation temperature of the preform. In another embodiment, the heating step preferably comprises heating at least a portion of the preform to a temperature between about 1000° C. and about 1400° C. In yet another embodiment, the heating step comprises heating at least a portion of the preform to a temperature between about 1000° C. and about 1400° C., then heating the at least a portion of the preform to a temperature between about 1400° C. and about 1550° C. In still another embodiment, the heating step comprises heating at least a portion of the preform to a temperature between about 1000° C. and about 1400° C., then heating the at least a portion of the preform to a temperature between about 1900° C. and about 2000° C. In yet another embodiment, the heating step comprises heating at least a portion of the preform to a temperature between about 1900° C. and about 2000° C.

The method further preferably comprises fusing a first optical waveguide fiber to one end of the selected portion of optical fiber and fusing a second optical waveguide fiber to the other end of the selected portion of optical fiber. In a preferred embodiment, the first optical waveguide fiber exhibits positive dispersion in a selected wavelength range and the second optical waveguide fiber exhibits negative dispersion in the selected wavelength range.

In another aspect, the present invention relates to a method of forming a transition optical waveguide fiber, the method comprising: fabricating a preform by providing a fused silica tube, placing a first pellet of a first type into the tube, and placing a second pellet of a second type into the tube adjacent the first pellet, and wherein adjacent surfaces of the first and second pellets form an interface; heating the preform; pulling on at least one end of the preform to draw an optical fiber therefrom, thereby stretching the interface into a transition region containing at least part of the first pellet and at least part of the second pellet; locating a portion of the optical fiber containing the transition region; and severing the portion of the optical fiber containing the transition region from the remainder of the optical fiber.

Preferably, the first and second pellets have differing compositions. In a preferred embodiment, the first and second pellets have differing refractive index profiles. In another preferred embodiment, the first and second pellets contain different dopants. In yet another embodiment, one of the pellets is formed from a fused silica preform capable of yielding a positive dispersion fiber and the other of the pellets is formed from a fused silica preform capable of yielding a negative dispersion fiber.

In a preferred embodiment, the method further comprises alternately placing pellets of the first and second types into the tube.

In a preferred embodiment, the method further comprises placing a plurality of pellets into the tube to form a plurality of interfaces. Even more preferably, at least two of the plurality of interfaces are stretched into at least two respective transition regions. In a preferred embodiment, at least two transition fibers are selectively severed from the drawn optical fiber. In yet another preferred embodiment, at least two interfaces are formed from at least three different types of pellets.

Preferably, the pellet is formed from a core rod.

In a preferred embodiment, the core rod is scored and a pellet shaped disc or pellet is formed from a portion of the core rod that is snapped from the remainder of the core rod at the score.

In yet another aspect, the present invention relates to an optical waveguide fiber comprising a transition core region including a first core portion and a second core portion, wherein the first and second portions are formed from disparate materials, wherein the first and second core portions are axisymmetrically disposed about a common longitudinal axis at the center of the fiber, wherein the first and second core portions share a generally conically-shaped interface, wherein parts of both the first core portion and the second core portion are disposed on at least one transverse plane perpendicular to the longitudinal axis, and wherein the transition region occupies at least the majority of the length of the fiber.

Preferably, the generally conically-shaped interface is axisymmetrically disposed about the common longitudinal axis.

Preferably, the generally conically-shaped interface is paraboloidal.

In a preferred embodiment, the first and second portions are formed from disparately structured pellets.

In a preferred embodiment, the transition region occupies substantially the entire length of the fiber. In another preferred embodiment, the transition region occupies the entire length of the fiber.

In a preferred embodiment, the fiber has a length between about 1 m and about 10 m. In another preferred embodiment, the fiber has a length between about 2 m and about 8 m. In yet another preferred embodiment, the fiber has a length between about 3 m and about 5 m. In still another preferred embodiment, the fiber has a length of about 3 m.

In yet another aspect, the present invention relates to an optical waveguide fiber span comprised of a first optical waveguide fiber connected to an intermediate optical waveguide fiber having a transition region with first and second portions, wherein the first connecting fiber is connected to the first portion of the transition region of the intermediate fiber. In a preferred embodiment, the span further comprises a second optical waveguide fiber connected to the second portion of the transition region.

Reference will now be made in detail to the present preferred embodiments of the invention, examples of which are illustrated in the accompanying drawings. For clarity of illustration and simplicity, elements shown in the figures have not necessarily been drawn to scale, and the dimensions of some of the elements have been exaggerated relative to other elements.

### BRIEF DESCRIPTION OF THE DRAWINGS

FIG. 1 schematically represents the relative refractive index profile of a positive dispersion fiber whose core cane may be used make core pellets according to the present invention.

FIG. 2 schematically represents the relative refractive index profile of a negative dispersion fiber whose core cane may be used make core pellets according to the present invention.

FIG. 3 schematically illustrates a longitudinal cross-sectional view of a fused silica tube having an inner surface defining a center hole which is loaded with pellets according to the present invention.

FIG. 4 schematically illustrates a longitudinal cross-sectional view of the progression of the transition region in an optical fiber preform with time as the corresponding optical fiber is drawn according to the present invention.

FIG. 5 schematically illustrates a longitudinal cross-sectional view of the interface boundary between the material of a first pellet and the material of a second pellet, after draw, according to the present invention.

FIG. 6 schematically represents a transverse cross-section of drawn fiber showing a refractive index profile corresponding to a first pellet according to the present invention.

FIG. 7 schematically represents a transverse cross-section of the fiber depicted in FIG. 6 drawn at a subsequent time.

FIG. 8 schematically represents a transverse cross-section of the fiber depicted in FIG. 7 drawn at a subsequent time.

FIG. 9 schematically represents a transverse cross-section of the fiber depicted in FIG. 8 drawn at a subsequent time.

FIG. 10 schematically represents a transverse cross-section of the fiber depicted in FIG. 9 drawn at a subsequent time.

FIG. 11 schematically represents a transverse cross-section of the fiber depicted in FIG. 10 drawn at a subsequent time.

FIG. 12 schematically represents a transverse cross-section of the fiber depicted in FIG. 11 drawn at a subsequent time.

FIG. 13 schematically illustrates a longitudinal cross-sectional view of a fused silica tube having an inner surface defining a center hole which is loaded with pellets according to another embodiment of the present invention.

### DETAILED DESCRIPTION OF THE PREFERRED EMBODIMENT

Additional features and advantages of the invention will be set forth in the detailed description which follows and will be apparent to those skilled in the art from the description or recognized by practicing the invention as described in the following description together with the claims and appended drawings.

Definitions

The following terminology and definitions are commonly used in the art.

The radii of the segments of the core is defined in terms of the index of refraction of the material of which the segment is made. A particular segment has a first and a last refractive index point. A central segment has an inner radius of zero because the first point of the segment is on the center line. In the case of step index, single segment index of refraction profiles, which are preferred in the present invention, the index of refraction typically reaches a peak value and then falls as the radius increases. The outer radius of such central segment is the radius drawn from the waveguide center line to the one-half peak point of the refractive index of the central segment. For a segment having a first point away from the center line, the radius from the waveguide center line to the location of its first refractive index point is the inner radius of that segment. Likewise, the radius from the waveguide center line to the location of the one-half peak refractive index point of the segment is the outer radius of that segment. The segment radii may be conveniently defined in a number of ways. In this application, radii are defined in accord with the figures, described in detail below.

The effective area is generally defined as,

A_{eff}=2π(∫E²rdr)²/(∫E⁴rdr)

wherein the integration limits are zero to ∞, and E is the electric field associated with the propagated light.

The mode field diameter, D_{mf}, is measured using the Peterman II method wherein, 2w=D_{mf} and w²=(2∫E²rdr/∫[dE/dr]²rdr), the intergral limits being 0 to ∞.

The relative index or relative refractive index of a segment, Δ%, as used herein, is defined by the equation,

Δ%=100×(ⁿᵢ²−n_{c}²)/2n_{c}²

where nᵢ is the maximum refractive index of the index profile segment denoted as i, and n_{c}, the reference refractive index, is taken to be the minimum index of the clad layer. Every point in the segment has an associated relative index.

The term refractive index profile or index profile is the relation between Δ% or refractive index and radius over a selected segment of the core.

Total dispersion, usually referred to as dispersion, is defined as the algebraic sum of waveguide dispersion and material dispersion. Total dispersion for single-mode fibers is also referred to as chromatic dispersion in the art. The units of total dispersion are ps/nm-km.

In accordance with the present invention, first and second fused silica bodies are provided, for example from first and second core blanks or core preforms of doped fused silica which are formed such that optical fiber drawn from the two preforms would have at least one disparate or dissimilar optical property. The fused silica bodies may also be variously referred to as pellets, or tablets, although the fused silica bodies may generally assume any of a variety of forms and/or sizes. In a preferred embodiment, the pellet has the form of a disc having the shape of a cylinder with a circular cross-section. In another preferred embodiment, the disc has an ellipsoidal cross-section.

The core preforms can be prepared by any known process, but preferably they are prepared using chemical vapor deposition (CVD) methods, wherein the glass is deposited in a soot form, and thereafter heated, preferably dried, and consolidated into a glass. While any such CVD method can be employed, examples of preferred CVD processes that can be employed to make the core preforms are outside vapor deposition (OVD), vapor axial deposition (VAD), modified chemical vapor deposition (MCVD) wherein a core layer is formed inside a glass tube, and plasma chemical vapor deposition (PCVD) wherein the reaction within the tube is plasma induced. Thus, the core preforms could be fabricated with known soot or glass or plasma laydown techniques, to achieve one or more desired optical properties, such as by imparting desired refractive index profile to each respective preform. The so-called core preform may comprise one or more layers of silica or doped silica which serve as core and/or cladding regions.

Core preforms containing silica-based soot are preferably dried with a cleaning gas such as chlorine, or a mixture of a cleaning gas and an inert gas, such as chlorine mixed with helium, and consolidated.

The core preforms are then heated and pulled or drawn, or “redrawn”, to provide a core rod or core cane of reduced diameter, i.e. compared to the initial consolidated preform from which the core rod or core cane were drawn. The cores may be preferably designed so that both of the core rods give the same desired cut-off wavelength.

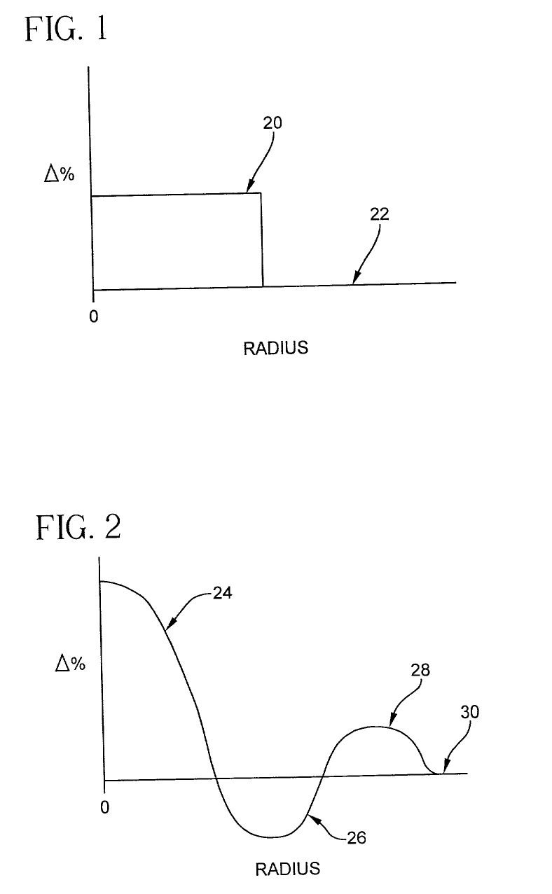

The first core rod may correspond to the core of a positive dispersion fiber, for example a standard single mode fiber like SMF-28™ of Corning Incorporated, as schematically represented by the relative refractive index profile seen in FIG. 1. The first core rod comprises a step index profile with a central core region 20 surrounded by an annular cladding region 22. The second core rod may correspond to the core of a negative dispersion fiber such as a dispersion compensation fiber, as schematically represented by the relative refractive index profile seen in FIG. 2. The second core rod comprises a central core region 24, surrounded by an annular moat region of depressed index, surrounded by an annular ring region, which is surrounded by a cladding region.

Various combinations of other types of fibers having various compositions and/or dopants and/or refractive indexes are also contemplated by the present invention. More than two types of core preforms may be prepared for subsequent processing as decribed below.

The core cane from each blank is then preferably made into respective pellets, or tablets, or discs, or fused silica bodies. The score and snap method may preferably be used, wherein a core rod is scored at a short distance from its end and then snapped off from the remainder of the core cane to form a pellet resulting in a clean break which should not require further surface treatment by, for example, application of abrasives. Other methods of severing a section of core rod from the remainder of the core rod may be used, such as a diamond abrasive loaded wheel saw.

The pellets may have any desired cross-sectional shape, such as circular, elliptical, quadrilateral, pentagonal, hexagonal, octagonal, etc., and the center hole of the fused silica tube and the pellets preferably have the same or similar cross-sectional shape. The center hole of the fused silica tube is preferably sized to be slightly larger than the outer periphery of the pellets to aid in placing or arranging the bodies therein. Preferably, two or more pellets comprise different refractive index profiles and/or are differently doped. Preferably, the pellets which are to be disposed in the same tube have the same outer diameter. Two or more pellets may comprise different thicknesses of cladding material or inner cladding. For example, if the doped portion of a first pellet terminates at a first diameter, and the doped portion of a second pellet terminates at a second diameter different from the first diameter, then one or both of the pellets preferably comprises another layer of silica-based material, in a preferred embodiment undoped silica, such that the outside diameters of the pellets are equal. In a preferred embodiment, two or more pellets of differing refractive index profile each comprise an inner cladding layer disposed at the circumferential periphery of the pellets wherein at least two pellets have inner claddings of different radial thicknesses. In another preferred embodiment, two or more pellets of differing refractive index profiles have equal outside diameters and equal inner cladding radial thicknesses.

Pellets from the different core canes are then placed, or arranged, or stacked, or disposed inside a fused silica tube or cylinder having a center hole. In one preferred embodiment, the tube is an appropriately sized heavy wall silica cylinder having a center hole opening adapted to receive the pellets and having a wall thickness sufficient to serve as cladding, or overcladding, for an optical fiber subsequently drawn therefrom. Alternately, the tube may have thinner walls, and an additional tube, and/or one or more layers of silica soot, may be applied to the exterior surface of the tube. The innermost tube thus serves as the receptacle for the various pellets formed from the disparate core canes.

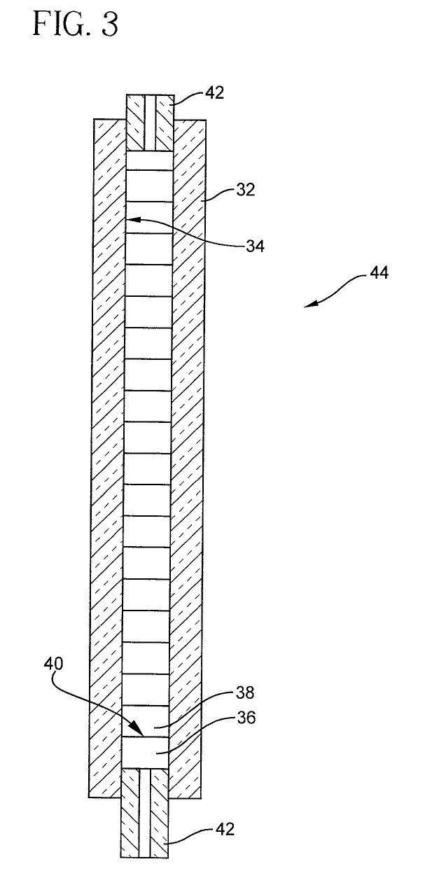

As schematically illustrated in FIG. 3, a fused silica tube 32 having an inner surface defining center hole 34 is provided. The center hole 34 of the fused silica tube 32 is loaded with the pellets such that at least first and second pellets, 36 and 38 corresponding to two disparate core canes, are placed adjacent to each other within the tube, wherein the first pellet 36 is of a first type of fused silica and the second pellet 38 is of a second type of fused silica. For example, the first pellet may be derived from a first preform which yields a positive dispersion fiber such as illustrated in FIG. 1, and the second pellet 38 may be derived from a second preform which yields a negative dispersion fiber such as illustrated in FIG. 2. A relatively short length of glass capillary tubing 42 having an inner surface which defines a smaller bore relative to the central hole 34 may be fused to one end of the tube 32 to prevent the pellets from exiting the tube 32. A second glass capillary tube 42 may be fused to the other end of the tube 32 to further lock in all of the pellets while allowing gas(es) to pass therethrough. Adjacent surfaces of the first and second pellets form an interface. In this arrangement, the assembly of the tube 32 and pellets (36, 38, etc.) may be regarded as a preform 44.

Preferably, the center hole 34 is exposed to a chlorine purge for a time and at a temperature sufficient to chemically clean the pellets as well as the inner surface of the tube 32. The chlorine purge may comprise passing chlorine gas or a combination of chlorine with an inert gas such as helium, into the center hole 34 and around the pellets 36, 38 disposed therein. Preferably, the cleaning gas purge is conducted at a temperature below the consolidation temperature of all of the members of the assembly or preform 44 so as to allow cleaning gas to make contact with as many surfaces as possible inside the center hole 34.

The preform 44 is then heated for a time and at a temperature sufficient to fuse the pellets to each other and to the tube in a seed-free manner. Preferably, the preform 44 is heated sufficiently to permit drawing thereof, a vacuum is applied to the centerhole 34, and at least one end of the preform is pulled to draw optical fiber therefrom. The pellets 36, 38 may fuse with each other and with the inside of the tube 32 by heating, for example to approximately 2000° C., before mechanical stretching, or the fusion may occur coincident with mechanical pulling upon the preform 44.

The first and second pellets 36, 38 and the interface 40 formed therebetween are then preferably drawn from the preform 44 into optical fiber, and the interface 40 stretches into a transition region.

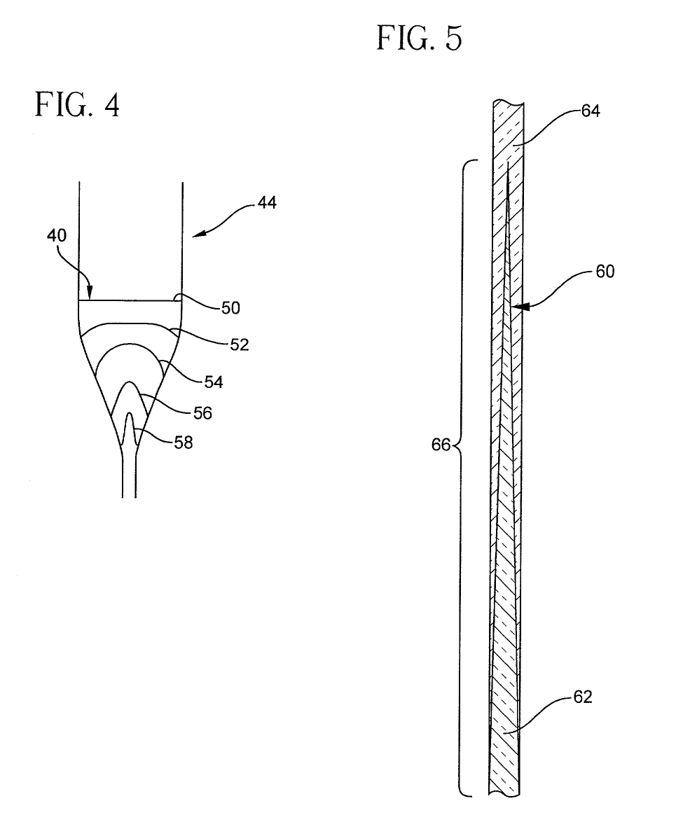

FIG. 4 schematically illustrates the progression of the transition region with time as the corresponding optical fiber is drawn from the preform 44. Line 50 represents the interface 40 at a time when the interface is essentially unaffected by the drawing on the preform, similar to the status of the interface just before or just after fusion between the adjacent pellets. Lines 52 to 58 represent the shape and position of the interface at successively later times, shown greatly exaggerated to illustrate development of the transition region as the preform is being drawn.

As schematically illustrated in FIG. 4, the cross-section of the preform 44 that contains the interface 40 between the first and second pellets bends toward the end of the preform being drawn. The interface between the first and second pellets becomes stretched into a transition region which smoothly and gradually tapers along the corresponding length of drawn fiber.

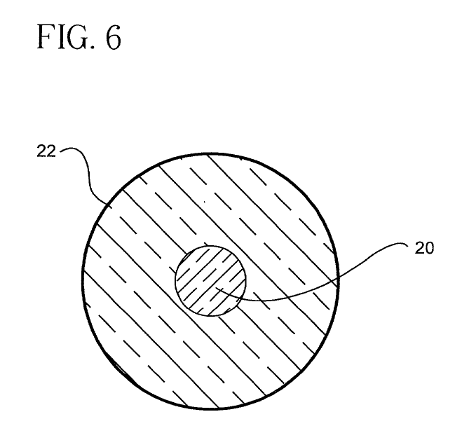

Upon drawing on the preform 44, the outer circumferential portion of a given yet-to-be-stretched cross section of the preform migrates toward the fiber drawing end of the preform sooner than more inwardly disposed portions of the same cross section of the preform when fiber is drawn from the preform. Accordingly, the interface is transformed from a substantially flat or planar orientation within the preform prior to draw, to a uniform, three-dimensional conical or paraboloidal boundary 60 between a first portion 62 comprised of at least a part of the material of the first pellet 36 and a second portion 64 comprised of at least a part of the second pellet 38, after draw, as schematically illustrated in FIG. 5.

The first portion 62 may comprise a cladding layer forming the outer periphery thereof, and the second portion 64 may comprise a cladding layer forming the outer periphery thereof. The cladding layer may comprise inner cladding and/or overcladding. The radial thicknesses of the cladding layers of the first portion 62 and the second portion 64 may differ since, for example, inner cladding layers of the first and second portions may differ. Preferably, the drawn product has a uniform outside diameter as depicted in FIG. 5, although the product may be drawn to a non uniform outside diameter.

The phenomenon schematically illustrated in FIG. 5 is beneficial to achieving a gradual transformation from the optical properties characteristic of the first pellet to the optical properties characteristic of the second pellet in a smooth integration between the two pellets that form the interface, thereby yielding a smooth, gradual taper that becomes a transition region of interest in the drawn optical fiber. The transition region 66 of interest in the fiber contains the cone-shaped or paraboloidal boundary between the materials from the first and second pellets. A transverse cross-section of the transition region would correspond to the initial shape of the pellets, e.g. circular, elliptical, quadrilateral, etc. The preform may be drawn into optical fiber or into a reduced diameter preform which may be subsequently drawn into optical fiber or which may be further clad, either by insertion into another tube or by deposition of additional soot layers, wherein the tube or soot layers may or may not comprise doped silica.

A greater number of interfaces per preform may be obtained for smaller thickness pellets, i.e. for shorter longitudinal lengths as measured parallel to the longitudinal axis of the preform. The minimum thickness of the pellets may be limited by the availability or practicality of various cutting means. The pellets in a given preform need not be of uniform thicknesses, since the region of interest would typically focus upon the transition region and perhaps some surrounding fiber portions.

In an exemplary embodiment, the preform 44 comprises the interface 40 between a first pellet 36 having a refractive index profile shown in FIG. 1 and a second pellet 38 having a refractive index profile shown in FIG. 2.

FIG. 6 schematically represents the cross-section of drawn fiber for the exemplary embodiment showing only a refractive index profile corresponding to the first pellet, namely the central core region 20 and cladding region 22.

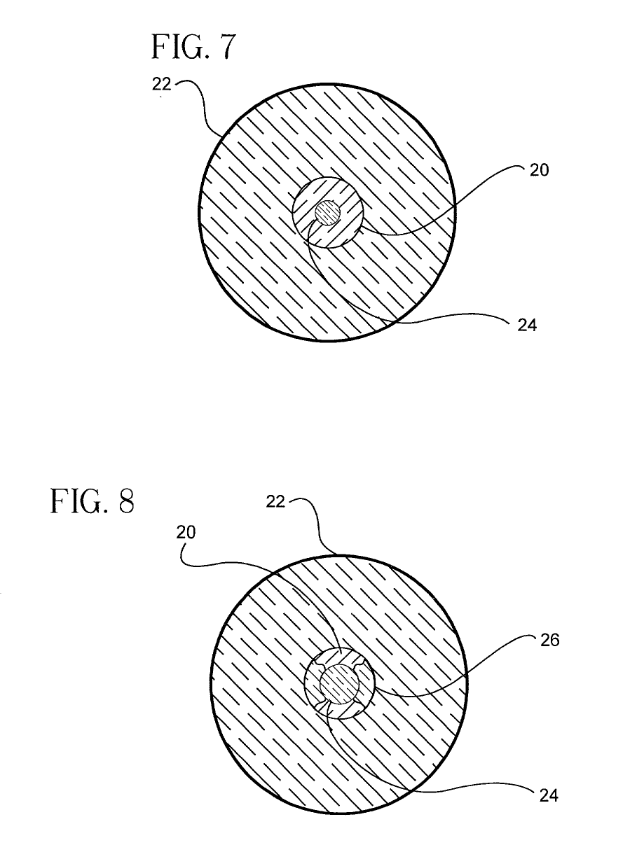

FIG. 7 schematically represents the cross-section of a subsequently drawn section of fiber showing a small portion of the central core region 24 corresponding to the second pellet 38 in the middle of a substantial portion of the central core region 20 corresponding to the first pellet 36.

FIG. 8 schematically represents the cross-section of a further subsequently drawn section of fiber showing a larger portion of the central core region 24 corresponding to the second pellet 38 surrounded by a combination of a small part of the central core region 20 corresponding to the first pellet 36 and a small part of the moat region 26 of the second pellet 38.

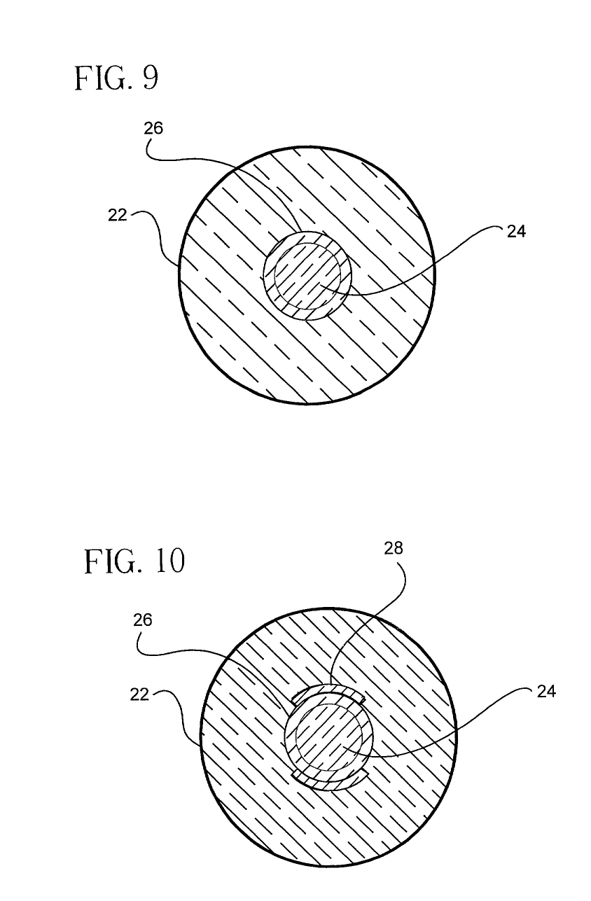

FIG. 9 schematically represents the cross-section of an even further subsequently drawn section of fiber showing the central core region 24 and the moat region 26 corresponding to the second pellet 38, wherein any contribution corresponding to the first pellet 36 is essentially absent at this transverse cross-section.

FIG. 10 schematically represents the cross-section of a still further subsequently drawn section of fiber showing the central core region 24, the moat region 26, and some traces of the ring region 28 corresponding to the second pellet 38.

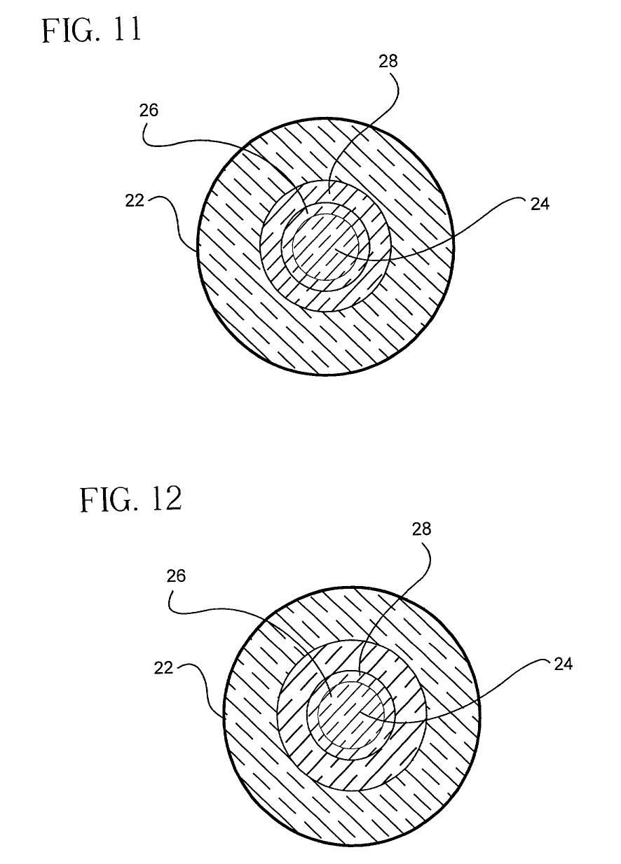

FIG. 11 schematically represents the cross-section of another further subsequently drawn section of fiber showing the central core region 24, the moat region 26, and a weak but intact ring region corresponding to the second pellet 38.

FIG. 12 schematically represents the cross-section of yet another further subsequently drawn section of fiber showing the central core region 24, the moat region 26, and the ring region 28 corresponding to the second pellet.

Preferably, the preform is sized and fabricated to result in a transition region having a length of between about lm and about 10 m. More preferably, the length of the transition fiber is greater than about 2 m and less than about 8 m. In one preferred embodiment, the length of the inventive fiber is approximately 3 m. Considerably longer lengths of fiber sections, essentially comprised of either first pellet material or second pellet material, bound the transition region on either side, prior to the extraction of the transition fiber therefrom.

After the optical fiber containing the transition region is drawn, the transition region must be located and separated from the remainder of the drawn fiber. One preferred technique of selecting the points of the fiber that will be severed in order to remove the transition fiber is by using an optical time domain reflectometer (OTDR). Optical time domain reflectometry is described in, for example, U.S. Pat. Nos. 5,450,191 and 5,479,251, both of which are incorporated herein by reference. An OTDR sends a short pulse of laser light down a fiber and observes the small fraction of light which is scattered back towards the source. Typically an OTDR may be used to locate defects in the drawn optical fiber, but here OTDR is utilized to analyze the backscatter phenomenon produced by the modefield mismatch between the two core types. In this manner, OTDR can be used to identify or locate a transition region of interest and precisely determine to what extent to rewind the optical fiber to extricate the lengths of interest.

Preferably, the selected section of optical fiber severed from the remainder of the drawn optical fiber contains essentially all of the transition region. Such a transition fiber or bridge fiber could be advantageously used in splicing two fibers having material and/or optical characteristics similar or identical to those of the first and second pellets. Furthermore, one or both ends of the selected section of optical fiber may include a section corresponding solely to the first or second pellets, respectively. In other embodiments, a smaller portion of the transition region may be selected, i.e. the entire transition region is not selected. In preferred embodiments, the transition region forms the majority of the length of the selected portion. In other embodiments, the transition region forms the minority of the length of the selected portion.

Although the present invention has been described in terms of first and second pellets thus far, preferably a plurality of pellets are placed into a tube to form a plurality of interfaces, as illustrated in FIG. 3. Thus, at least two of the plurality of interfaces are stretched into at least two respective transition regions, and at least two transition fibers are selectively severed from the drawn optical fiber. Furthermore, various combinations of pellets may be placed in a given tube. For example, at least two interfaces may be formed from at least three different types of pellets. That is, a plurality of bridge fibers or transition fibers may be obtained from a single preform. Each transition fiber may differ from the other transition fibers from the same preform, or at least two transition fibers from the same preform may have similar or substantially the same properties and/or structure.

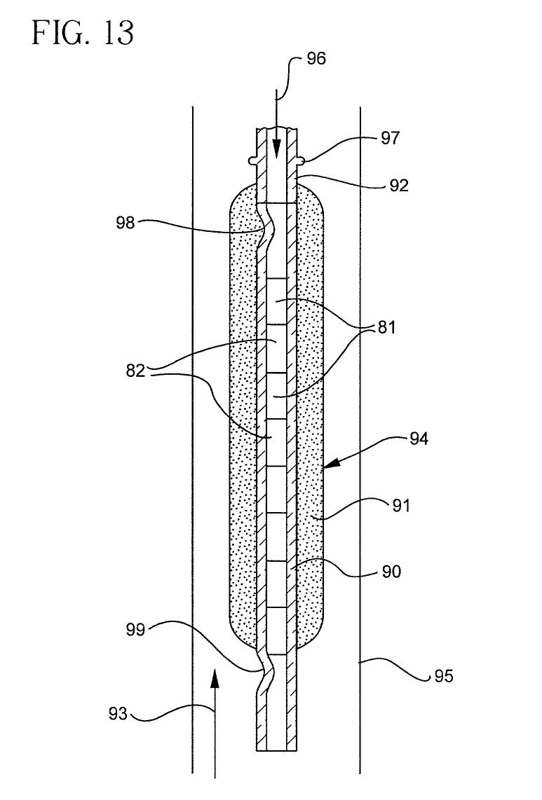

In another embodiment schematically illustrated in FIG. 13, two or more cylindrical preforms are formed that are capable of being overclad and formed into optical fibers having disparate optical characteristics. For example, first and second preforms are cut into pellets 81 and 82, respectively. The tablets can be made by the simple score and snap method or by another method, such as using a diamond abrasive loaded wheel saw. The ends of the resultant tablets may then be polished.

A tubular glass handle 92 having an annular enlargement 97 may be fused to one end of an elongated glass tube 90. Handle 92 may be part of a ball joint type gas feed system of the type disclosed in U.S. Pat. No. 5,180,410. Enlargement 97 is adapted to rest on a slotted base of a support tube (not shown) that suspends handle 92 in a consolidation furnace. Tube 90 is heated and a dent 98 is formed near handle 92. Alternatively, that part of handle 92 adjacent tube 90 could be dented. The assembly including tube 90 and handle 97 is inserted into a lathe (not shown) and rotated and translated with respect to burner 100 which deposits on tube 90 a layer 91 of cladding glass particles or soot (see FIG. 9). Alternatively, burner 100 may translate with respect to the assembly. Silica layer 91 can be built up to a sufficient outside diameter (OD) that the resultant preform can be consolidated and drawn into an optical fiber having desired optical characteristics. Layer 91 can overlap handle 92 as shown in FIG. 13.

Tube 90 may be oriented so that the end affixed to handle 92 is lower than the other end, and tablets 81 and 82 are alternately inserted into the upper end of tube 90. The tablets are prevented from falling by dent 98. Tube 90 is heated and a dent 99 is formed near that end opposite dent 98. When tube 90 is inverted, dent 99 prevents the tablets from falling therefrom.

Handle 92 may then be suspended from a support tube (not shown) which is lowered to insert assembly 94 into consolidation furnace muffle 95. While assembly 94 is heated in the consolidation furnace, a cleaning gas flows upwardly through the furnace (arrow 93). The cleaning gas preferably conventionally comprises a mixture of chlorine and an inert gas such as helium. A chlorine-containing gas stream (arrow 96) is flowed from tube 92 into tube 90. Pure chlorine may also be used. The diameter of each of the tablets 81 and 82 is slightly smaller than the inner diameter of tube 90 so that the chlorine flows around the entire periphery of each of the tablets and flows or diffuses between adjacent tablets. The chlorine then exhausts through the bottom of tube 90. The chlorine functions as a hot chemical cleaning agent. During this hot chlorine cleaning step, the local temperature is set below the consolidation temperature of soot layer 91 so that the space between tablets 81 and 82 and tube 90 remains open for a sufficient length of time for the required cleaning to occur. The chlorine cleaning step is more effective at high temperatures. It is preferred that the temperature of the cleaning step be at least 1000° C., since at lower temperatures, the duration of the step would be sufficiently long that the step would be undesirable for commercial purposes. Lower temperatures could be employed if processing time were not a concern. The flow of hot chlorine between the tube 90 and tablets 81 and 82 beneficially allows the surfaces of adjacent tablets and of tube and tablets to be brought together without the formation of seeds at their interface. Seeds include defects such as bubbles and impurities. Oxygen at elevated temperature is also beneficial at removing organic contaminants.

The assembly 94 is lowered further into the furnace muffle, and the wall of the corresponding portion of tube 90 at the end of soot layer 91 collapses and fuses together, thereby cutting off the centerline chlorine flow. As an optional step, a valve can then be switched to pull a vacuum within tube 90. As assembly 94 continues advancing into the furnace muffle, first the tip and then the remainder of the assembly is subjected to the maximum furnace temperature which is sufficient to consolidate layer 91. Soot layer 91 shrinks both radially and longitudinally as it consolidates. Longitudinal shrinkage of the soot layer 91 causes tube 90 to decrease in length, which causes adjacent tablets 81 and 82 to be forced together while being subjected to consolidation temperature and to fuse together without forming seeds.

Radial shrinkage of soot layer 91 exerts a force radially inwardly on tube 90 which urges tube 90 inwardly against tablets 81 and 82 to form a fused assembly 98 (see FIG. 10) in which the three regions 81, 90′ and 91′ are completely fused together. Region 90′ is the collapsed tube, and region 91′ is the consolidated layer. A relatively low density soot provides a greater inwardly directed force; however, the soot coating must be sufficiently dense to prevent cracking.

Preferably, the tablet-filled overclad tube is consolidated to yield a seed free preform, a cleaning gas such as chlorine is preferably flowed through the tube.

The fused assembly is removed from the consolidation furnace. Regions 90′ and 91′ of fused assembly 98 function as cladding in the resultant optical fiber. Assembly 98 can be used as a draw blank and can be drawn directly into an optical fiber. Fused assembly 98 can optionally be provided with additional cladding prior to the fiber drawing step. For example, a layer of cladding soot can be deposited onto assembly 98 and then consolidated. Alternatively, assembly 98 can be inserted into a cladding glass tube.

The method is self aligning in that adjacent core canes of different diameter will be centered on the axis of the resultant draw blank when tube 90 collapses inwardly during the consolidation of porous glass layer 91.

### EXAMPLE

The invention will be further clarified by the following example which is intended to be exemplary of the invention.

First and second core blanks or core preforms of doped fused silica were formed by a known OVD process such that optical fiber drawn from the two preforms would have at least one dissimilar optical property. The preforms contained silica-based soot and were cleaned with a cleaning gas such as chlorine, or a mixture of a cleaning gas and an inert gas, such as chlorine mixed with helium, and consolidated. Preferably, organic material is removed by exposing the preform to oxygen at a temperature preferably between about 1000° C. and 1200° C.

Each of the preforms was then heated and drawn, or “redrawn”, to provide a core rod or core cane of reduced diameter, i.e. compared to the initial consolidated preform from which the core rod or core cane were drawn. Core rod was redrawn from each of the core blanks down to a diameter of 5.5 mm OD. The cores were designed so that both of the 5.5 mm OD core rods simultaneously give a desired cut-off wavelength. The first core rod corresponded to the core of a positive dispersion fiber with a mode field of about 11 □. The second core rod corresponded to the core of a negative dispersion (dispersion compensation) fiber with a mode field of about 5.5 □.

The core cane from each blank was then made into pellets. The score and snap method was used, wherein a core rod is scored at a short distance from its end and then snapped off from the remainder of the core cane, resulting in a clean break.

In the preferred embodiment, the pellets from the two core canes were then alternately placed or arranged or stacked or disposed into an appropriately sized heavy wall silica cylinder. A fused silica cylinder or tube was provided having an inside diameter of about 6 mm and an outside diameter of about 24 mm OD. The tube served as the receptacle for the 5.5 mm pellets of the different core canes. The tube also served as a cladding portion, or overcladding, around the tablets or core cane.

The centerhole of the silica cylinder loaded with the pellets was then exposed to a centerhole chlorine purge at approximately 1300° C. for about 1 hour to chemically clean the pellets.

The preform or pellet blank was then redrawn under vacuum of approximately 1 Torr and at approximately 2000° C. to fuse the pellets in a seed-free manner. The preform was then redrawn into fiber.

An OTDR scan of the drawn fiber clearly revealed the locations of the transition regions which corresponded to the interfaces between adjacent pellets. The OTDR instrument was thus used to precisely determine to what extent to rewind the optical fiber to extricate the lengths of interest.

Tests revealed that for the above example, the transition region or splice union occurred over approximately 3 meters of fiber length. The gradual transition helps account for the low splice losses achieved by the present invention.

For purposes of comparison, an intermediate optical fiber having a mode field in between the size of the mode fields of the first and second core materials was spliced to corresponding positive and negative dispersion fibers and compared to the example of the present invention similarly spliced to positive and negative dispersion fibers. The intermediate fiber resulted in a 0.4 dB/km splice loss, while the present invention yielded a splice loss of around 0.06 dB/km. Such low splice losses are especially important in undersea applications.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention. It will be apparent to those skilled in the art that various modifications and variations to the embodiment(s) of the invention as described herein can be made without departing from the spirit or scope of the invention as defined by the appended claims and their equivalents.

What is claimed is:

1. A method of forming an optical waveguide fiber, the method comprising:
providing a preform comprising a fused silica tube, a first pellet disposed in the tube, and a second pellet disposed in the tube adjacent the first pellet, wherein the first and second pellets are of disparate types, and wherein adjacent surfaces of the first and second pellets form an interface;
heating the preform;
pulling on at least one end of the preform to draw an optical fiber therefrom, thereby stretching the interface into a transition region which contains at least a portion of both the first and second pellets; and
severing a selected portion of the optical fiber, the selected portion containing at least part of the transition region, wherein the at least part of the transition region forms the majority of the selected portion.

2. The method according to claim 1 further comprising applying a layer of silica soot to the exterior surface of the preform.

3. The method according to claim 2 further comprising consolidating the layer of silica soot.

4. The method according to claim 1 wherein the selected portion has a length of less than about 10 m.

5. The method according to claim 1 wherein the selected portion has a length of less than about 5 m.

6. The method according to claim 1 wherein the selected portion has a length of less than about 3 m.

7. The method according to claim 1 wherein the preform is fabricated by providing a fused silica tube, placing a first pellet into the tube, and placing a second pellet into the tube adjacent the first pellet.

8. The method according to claim 1 further comprising exposing the preform to a cleaning gas.

9. The method according to claim 8 wherein the preform is exposed to a cleaning gas while being heated.

10. The method according to claim 1 wherein the selected portion contains essentially all of the transition region, and wherein the transition region forms the majority of the length of the selected portion.

11. The method according to claim 1 wherein the heating step comprises heating at least a portion of the preform to a temperature above about 1000° C. and less than the consolidation temperature of the preform.

12. The method according to claim 1 wherein the heating step comprises heating at least a portion of the preform to a temperature between about 1000° C. and about 1400° C.

13. The method according to claim 1 wherein the heating step comprises heating at least a portion of the preform to a temperature between about 1000° C. and about 1400° C., then heating the at least a portion of the preform to a temperature between about 1400° C. and about 1550° C.

14. The method according to claim 1 wherein the heating step comprises heating at least a portion of the preform to a temperature between about 1000° C. and about 1400° C., then heating the at least a portion of the preform to a temperature between about 1900° C. and about 2000° C.

15. The method according to claim 1 wherein the heating step comprises heating at least a portion of the preform to a temperature between about 1900° C. and about 2000° C.

16. The method according to claim 1 further comprising fusing a first optical waveguide fiber to one end of the selected portion of optical fiber and fusing a second optical waveguide fiber to the other end of the selected portion of optical fiber.

17. The method according to claim 16 wherein the first optical waveguide fiber exhibits positive dispersion in a selected wavelength range and the second optical waveguide fiber exhibits negative dispersion in the selected wavelength range.

18. A method of forming a transition optical waveguide fiber, the method comprising:
fabricating a preform by providing a fused silica tube, placing a first pellet of a first type into the tube, and placing a second pellet of a second type into the tube adjacent the first pellet, and wherein adjacent surfaces of the first and second pellets form an interface;
heating the preform;
pulling on at least one end of the preform to draw an optical fiber therefrom, thereby stretching the interface into a transition region containing at least part of the first pellet and at least part of the second pellet;
locating a portion of the optical fiber containing the transition region; and
severing the portion of the optical fiber containing the transition region from the remainder of the optical fiber.

19. The method according to claim 18 wherein the first and second pellets have differing compositions.

20. The method according to claim 18 wherein the first and second pellets have differing refractive index profiles.

21. The method according to claim 18 wherein the first and second pellets contain different dopants.

22. The method according to claim 18 wherein one of the pellets is formed from a fused silica preform capable of yielding a positive dispersion fiber and the other of the pellets is formed from a fused silica preform capable of yielding a negative dispersion fiber.

23. The method according to claim 18 further comprising alternately placing pellets of the first and second types into the tube.

24. The method according to claim 18 further comprising placing a plurality of pellets into the tube to form a plurality of interfaces.

25. The method according to claim 24 wherein at least two of the plurality of interfaces are stretched into at least two respective transition regions.

26. The method according to claim 25 wherein at least two transition fibers are selectively severed from the drawn optical fiber.

27. The method according to claim 24 wherein at least two interfaces are formed from at least three different types of pellets.

28. The method according to claim 18 wherein the pellet is formed from a core rod.

29. The method according to claim 28 wherein the core rod is scored and the pellet is snapped from the core rod at the score.

30. An optical waveguide fiber comprising:
a transition core region including a first core portion and a second core portion;
wherein the first and second portions are formed from disparate materials;
wherein the first and second core portions are axisymmetrically disposed about a common longitudinal axis at the center of the fiber;
wherein the first and second core portions share a generally conically-shaped interface;
wherein parts of both the first core portion and the second core portion are disposed on at least one transverse plane perpendicular to the longitudinal axis; and
wherein the transition region occupies at least the majority of the length of the fiber.

31. The optical waveguide fiber according to claim 30 wherein the generally conically-shaped interface is axisymmetrically disposed about the common longitudinal axis.

32. The optical waveguide fiber according to claim 30 wherein the generally conically-shaped interface is paraboloidal.

33. The optical waveguide fiber according to claim 30 wherein the first and second portions are formed from disparately structured pellets.

34. The optical waveguide fiber according to claim 30 wherein the transition region occupies substantially the entire length of the fiber.

35. The optical waveguide fiber according to claim 30 wherein the transition region occupies the entire length of the fiber.

36. The optical waveguide fiber according to claim 30 wherein the fiber has a length between about 1 m and about 10 m.

37. The optical waveguide fiber according to claim 30 wherein the fiber has a length between about 2 m and about 8 m.

38. The optical waveguide fiber according to claim 30 wherein the fiber has a length between about 3 m and about 5 m.

39. The optical waveguide fiber according to claim 30 wherein the fiber has a length of about 3 m.

40. An optical waveguide fiber span comprising a first optical waveguide fiber connected to the optical waveguide fiber of claim 30, wherein the first connecting fiber is connected to the first portion of the transition region of the optical waveguide fiber of claim 30.

41. The optical waveguide fiber according to claim 40 further comprising a second optical waveguide fiber connected to the second portion of the transition region.
